(19) United States
(12) Patent Application Publication
(10) Pub. No.: US 2024/0408557 A1
(43) Pub. Date: Dec. 12, 2024

(54) APPARATUS FOR MIXING AND DOSING CHLORINE IN WATER

(71) Applicant: SEKO S.P.A., CITTADUCALE (IT)

(72) Inventor: Stefano FOLIO, Cittaducale (IT)

(21) Appl. No.: 18/697,036

(22) PCT Filed: Oct. 11, 2022
(86) PCT No.: PCT/IB2022/059728

§ 371 Date: Mar. 29, 2024

(30) Foreign Application Priority Data
Oct. 12, 2021 (IT) 102021000026150

(51) Int. Cl. B01F 25/60; B01F 21/20; B01F 23/50; B01F 35/53; B01F 35/71; B01F 101/00; E04H 4/12

(52) U.S. Cl. CPC B01F 25/60; B01F 21/22; B01F 23/56; B01F 35/53; B01F 35/71805; B01F 2101/2204; E04H 4/1281

(57) ABSTRACT

An automated mixing and dosing apparatus comprises a suction line, in fluid communication with an inlet through which to suck water, a hydraulic pump operatively connected in suction to the suction, a logic control unit, a first delivery line connected to the hydraulic pump, in delivery, to feed the sucked water to a perforated basket through a dispenser, wherein the dispenser is positioned at a top of the perforated basket and is configured to selectively deliver jets of pressurized water inside it to dissolve the chlorine tablets present in the perforated basket, a collection tank wherein to collect the dissolved chlorine, a second delivery line, in fluid communication with the pump delivery and with an outlet of the mixing apparatus, through which to deliver a mixed liquid, a mixing line which places the collection tank in fluid communication with the second delivery line, and is connected to the second delivery line through a Venturi tube.

The present invention relates to an automatic apparatus for mixing and dosing chlorine in water.

In particular, the present invention relates to an equipment for mixing chlorine in the water of a swimming pool starting from chlorine in solid form such as, for example, tablets, tablets, granules or the like.

In the following description reference will be made to an apparatus for mixing and dosing chlorine in water while it is intended that alternative embodiments of the invention can be used for mixing alternative materials which are supplied in solid form and must be dissolved in water.

In a swimming facility it is known the use of chlorine to dissolve in water for hygiene reasons. Chlorine, in fact, is an oxidizing and disinfectant substance and is highly effective against numerous pathogens that can spread in water. Chlorine, however, is an irritant and, for this reason, its concentration in the water must be kept within a predetermined range, in order to ensure proper disinfectant action without causing irritation.

The chlorine concentration varies over time and, as far as possible, must be kept within the aforementioned range.

Normally, a chlorine mixture is prepared by dissolving powdered chlorine in buckets which are then poured into the pool water.

This operation exposes the operator preparing the mixture to the irritating action of powdered chlorine, which is very dangerous and causes severe irritation if inhaled or manipulated.

The use of chlorine in granules or tablets reduces the risk of inhalation or direct contact with chlorine powder while not eliminating this risk as the tablets can be damaged and release dust during their handling.

Document U.S. Pat. No. 4,056,470 describes an automatic system to be connected to a swimming pool plumbing system to produce a chlorine solution to be mixed in the water that is circulated in this system.

The automatic mixing system includes a perforated basket wherein chlorine tablets are put, wherein the basket is drowned in a tank that is selectively crossed by the flow of water that is forced along the plumbing system of the swimming pool.

A floating-type valve determines the selective opening or closing of the tank to allow the selective introduction of a chlorine-saturated solution into the pool water and thus regulate the concentration of chlorine in the pool itself.

This solution allows to solve the safety problems mentioned above in relation to the handling of chlorine by an operator as it does not require the use of powder to be mixed manually in a bucket of water.

However, the aforesaid automatic mixing system is not free from drawbacks in relation to its flexibility of use and the consumption of chlorine.

In fact, this automatic mixing system does not allow you to adjust the concentration of chlorine dissolved in the saturated solution which is then introduced into the water flow fed into the pool. Furthermore, continuous maintenance is required of the tank wherein the chlorine saturated solution is present, to keep the internal walls clean and remove any deposits that adhere to them and which could compromise the correct operation of the valves in the tank.

Documents WO 2013/050981A1 and US 2020/053958 A1 describe further automatic systems for mixing chlorine in water which, similarly to what has been described above, have limits of use in relation to the maintenance of the tank wherein the saturated chlorine solution is present.

There is therefore the need to prepare a chlorine solution in a safe and automated way to be introduced into the water of a swimming pool system to maintain the chlorine concentration within the water within a predetermined range, within an efficient solution, which requires limited intervention by an operator and which is reliable over time.

The purpose of the invention is to allow in a simple, efficient, practical and automated way the preparation of a chlorine solution to be mixed and dosed in the water fed to a swimming pool to maintain the chlorine concentration in the pool within a predetermined range.

Another purpose of the invention is to limit the manipulation of chlorine by an operator, reducing the risks associated with direct exposure to chlorine, to obtain a chlorine solution to be introduced into the water of a swimming pool.

A further object of the present invention is to automate the preparation, dosing and dispensing of a chlorine solution to be diluted in water according to a simple and flexible use solution, which is easily adaptable to specific use requirements, that is to say depending on the quantity of water to be treated and the concentration of chlorine dissolved in the water that you want to ensure constantly over time.

Still another object of the present invention is to optimize the consumption of chlorine to be dissolved, avoiding a waste of this substance.

The specific object of the invention is an automated mixing and dosing equipment, comprising:
a suction line, in fluid communication with an inlet through which to suck water,
a hydraulic pump operatively connected in suction to said suction line,
a programmable logic control unit, operatively connected to the hydraulic pump to selectively control its operation,
a first delivery line connected to the delivery hydraulic pump to feed the water sucked to a tank compartment delimited at a top of the mixing equipment, wherein the tank compartment includes:
a perforated basket wherein to house a solid material to be dissolved,
a dispenser operatively connected to the first delivery line, wherein the dispenser is positioned at a top of the perforated basket and is configured to selectively deliver jets of pressurized water inside the perforated basket to dissolve the solid material therein contained,
a collection tank wherein to collect a saturated solution of the dissolved material that drips through a bottom of the perforated basket,
a second delivery line in fluid communication, in delivery, with the pump and with an outlet of the mixing equipment through which to deliver a mixed liquid,
a mixing line which places the collection tank in fluid communication with the second delivery line, wherein the mixing line is connected in fluid communication with the second delivery line by means of a Venturi tube connected along a section of the delivery line, so that the passage of water through the second delivery line determines the aspiration of the solution contained in the collection tank by the effect of the Venturi tube, mixing the solution with the water which is then delivered through the exit.

According to another aspect of the invention, the dispenser can have a frame conformation and comprises a hydraulic inlet connection connected to a first branch, wherein the first branch departs in fluid communication from the first delivery line, wherein the dispenser comprises two perforated pipes which extend parallel to each other and are mechanically joined and in fluid connection by respective transversal pipes, the perforated pipes being in fluid communication with the hydraulic inlet connection.

According to a further aspect of the invention, each of the perforated tubes can have a plurality of through holes which are arranged in alternating succession to each other along a first row and a second row, wherein the first row and the second row are angularly offset from each other and wherein the holes of the first row are offset with respect to the holes of a second row, the holes being positioned so that the water jets that can be dispensed by them are directed towards the inside of the perforated basket on which the dispenser faces the inside the tank compartment.

According to an additional aspect of the invention, the hydraulic connection can be connected to one end of one of the transverse pipes, so as to extend at a vertex of the frame structure, wherein the hydraulic connection is rotatable around an axis of rotation to allow the dispenser to be raised or lowered relative to the perforated basket.

According to another aspect of the invention, the mixing and dosing apparatus can comprise brackets for supporting the perforated basket in an elevated position with respect to the collection tank, the brackets being positioned at the top of the mixing apparatus, inside of the tank compartment, optionally wherein each of the support brackets has notches for housing respective bottom portions which protrude from a bottom end of the perforated basket.

According to a further aspect of the invention, the mixing and dosing apparatus can comprise a delivery tube which extends inside a top portion of the collection tank and is connected, in fluid communication, to a second branch which the delivery line extends into fluid communication with the first delivery line, comprising a plurality of holes through which jets of pressurized water can be delivered directed towards an inclined bottom on which the delivery line faces, wherein the inclined bottom delimits a bottom of the collection tank. According to an additional aspect of the invention, the mixing and dosing apparatus can comprise a first delivery valve configured to selectively intercept the first branch and a second delivery valve configured to selectively intercept the second branch, wherein the first delivery valve and the second delivery valve are operatively connected to the control logic unit.

According to another aspect of the invention, the mixing and dosing apparatus can comprise a lid hinged to a top portion of the mixing and dosing apparatus, wherein the lid selectively releases an access opening to the tank compartment, wherein the lid comprises an insert embedded in it and configured to interact with a sensor arranged at the tank compartment, wherein the sensor is operatively connected to the control logic unit and configured to detect when the lid is in the closed position.

According to a further aspect of the invention, the mixing and dosing apparatus can comprise an outlet valve configured to selectively intercept a fluid communication between the collection tank and the mixing line, wherein the outlet valve comprises a valve body configured as a perforated cage inside which a shutter configured as a spherical float is housed, wherein the spherical float can be moved between an open position and a closed position according to the level of the liquid contained in the collection tank.

According to an additional aspect of the invention, the mixing and dosing apparatus can comprise an auxiliary tank, an auxiliary line which places the auxiliary tank in fluid communication with the interior of the collection tank, and an auxiliary outlet valve positioned inside the interior of the collection tank is configured to selectively place the auxiliary tank and the collection tank in fluid communication, selectively intercepting the auxiliary line according to the level of liquid included in the collection tank.

According to another aspect of the invention, the mixing and dosing apparatus can comprise an auxiliary delivery line which connects, in fluid communication, an outlet of the auxiliary tank with the mixing line, along a section of the upstream mixing line of the Venturi tube, wherein the auxiliary delivery conduit comprises an interception valve configured to selectively intercept it, the interception valve being operatively connected to the control logic unit.

According to a further aspect of the invention, the mixing and dosing apparatus can comprise a hollow base on which the mixing and dosing apparatus rests, the hollow base having a bottom bounded perimeter by side walls and comprising inside it some crosspieces which support the mixing and dosing apparatus in a raised position with respect to the bottom, wherein the mixing and dosing apparatus comprises a vent line which places the inside of the tank in fluid communication with the hollow base when the liquid contained in the collection tank exceeds a predetermined maximum level.

According to an additional aspect of the invention, the mixing and dosing apparatus can comprise a dispensing device for the controlled dispensing of an acid substance to be selectively fed into the collection tank through the dispensing tube, wherein the dispensing device dispensing comprises a peristaltic pump in fluid communication with a hydraulic connection connected along the second branch, wherein the dispensing device is operatively connected to the control logic unit.

The advantages offered by a mixing and dosing equipment according to the invention are evident.

The mixing and dosing apparatus according to the invention is configured to automatically prepare and mix a solution saturated with chlorine in a water flow to be fed to a swimming pool when required and to then perform an internal cleaning to optimize the use of chlorine fed into a tank compartment avoiding the formation of residual chlorine inside.

The mixing and dosing equipment is configured to be connected to a swimming pool water treatment system, thus making it easy to implement in the system itself.

In particular, the mixing and dosing apparatus according to the invention comprises a reservoir compartment located at the top of the apparatus itself, inside which chlorine can be fed in solid form, for example in tablets or tablets or in granules, which is selectively sprayed with water when it is necessary to prepare a saturated solution of chlorine, avoiding waste of this material.

In addition, the mixing and dosing equipment allows water to be introduced into a collection tank where the dissolved chlorine is collected, providing a further possibility to regulate the concentration of chlorine in the solution to be introduced into the water of a swimming pool.

The present invention will now be described, for illustrative but not limitative purposes, according to its preferred embodiments, with particular reference to the Figures of the attached drawings, wherein:

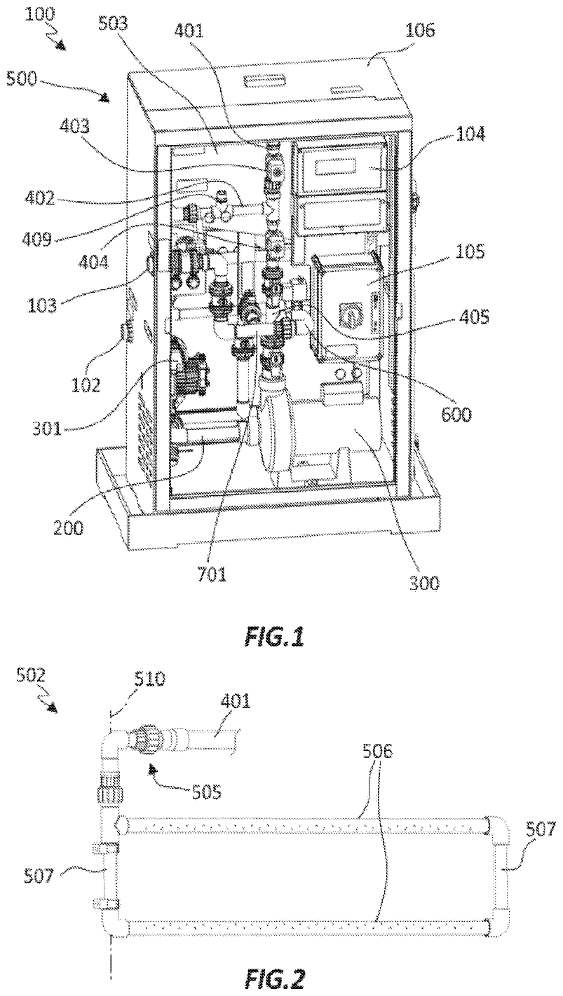

FIG. 1 shows a front perspective view of a mixing and dosing equipment according to the invention;

FIG. 2 shows a detailed view from below of some components of the mixing and dosing equipment according to the invention;

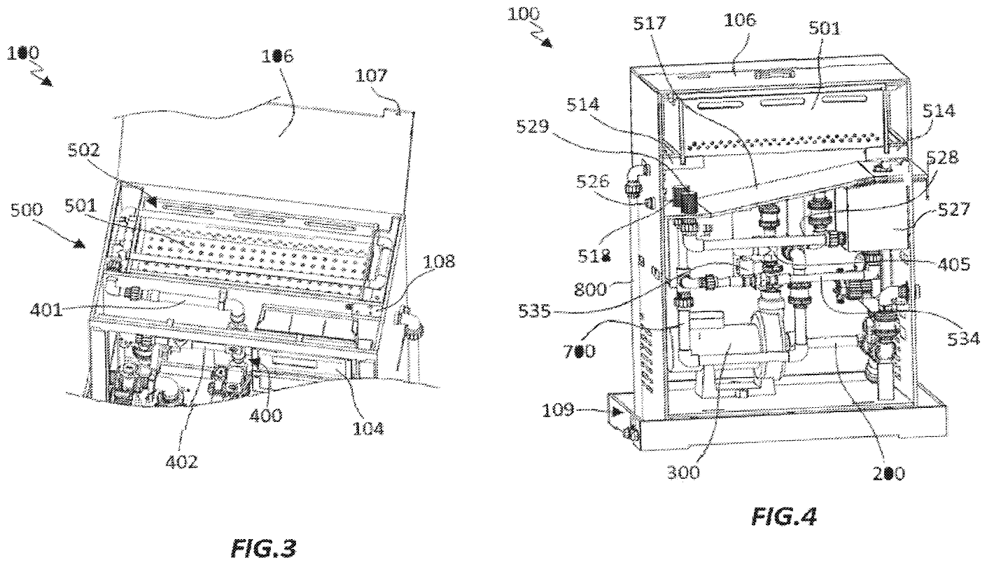

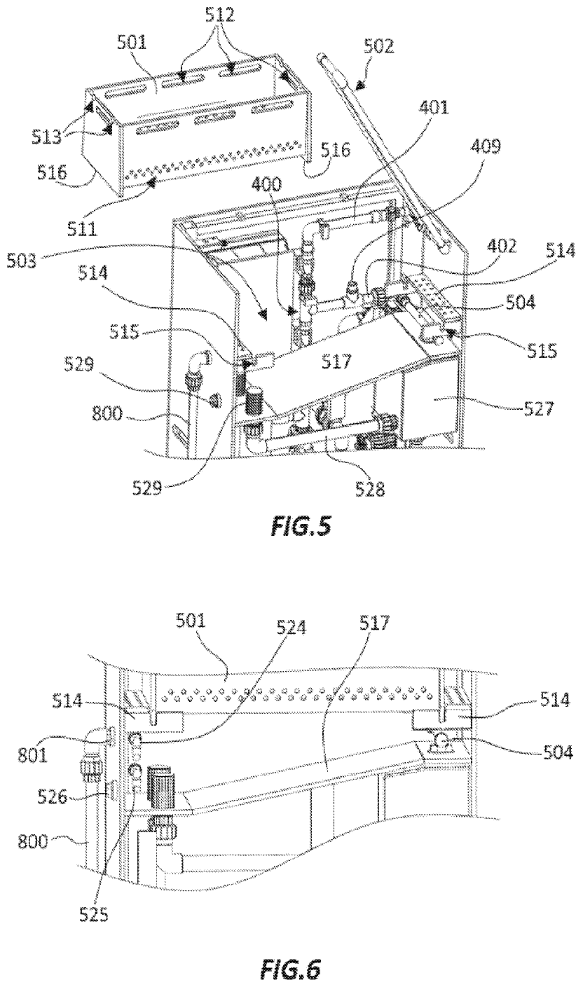

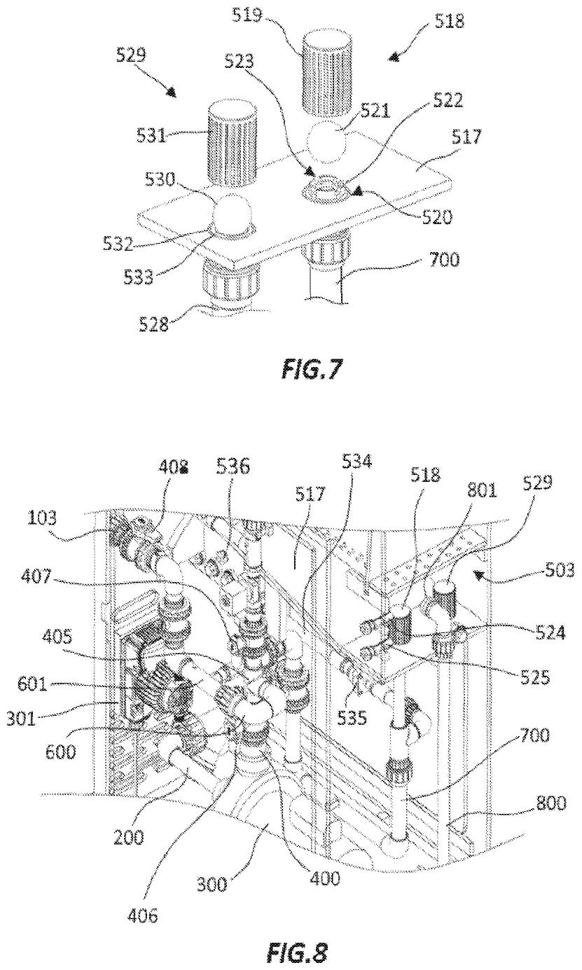

FIG. 3 shows a perspective view from above of some components of the mixing and dosing equipment according to the invention;

FIG. 4 shows a rear perspective view of the mixing and dosing equipment according to the invention;

FIG. 5 shows a partially exploded perspective view of some components of a top portion of the mixing and dosing equipment according to the invention;

FIG. 6 shows a detailed side perspective view of some components of the mixing and dosing equipment according to the invention;

FIG. 7 shows a detailed perspective view of some internal components of the mixing and dosing equipment according to the invention;

FIG. 8 shows a detailed front perspective view of some internal components of the mixing and dosing equipment according to the invention;

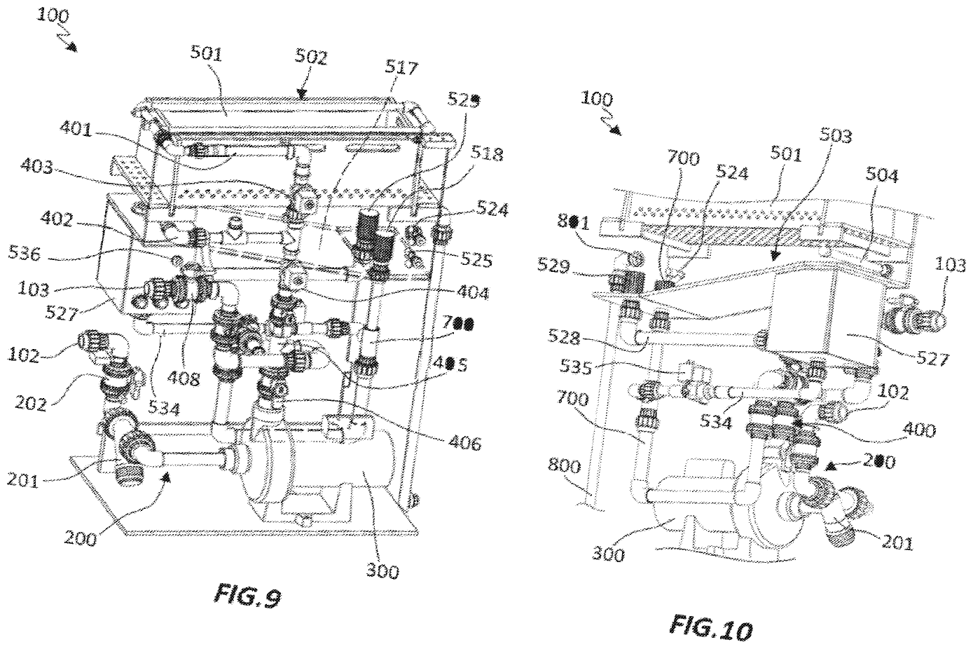

FIG. 9 shows a front perspective view from above of some components of the mixing and dosing equipment according to the invention;

FIG. 10 shows a rear perspective view from below of some components of the mixing and dosing equipment according to the invention;

FIG. 11 shows a partially exploded front perspective view of the mixing and dosing equipment according to the invention;

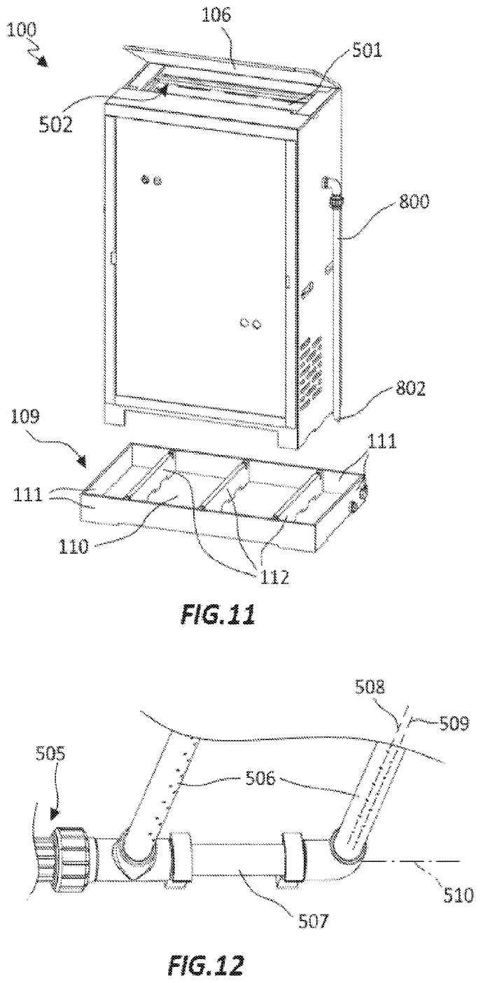

FIG. 12 shows a detailed view of some components of the mixing and dosing equipment according to the invention. In the following description, the directional terminology, such as “right”, “left”, “front”, “rear”, “base”, “top”, “upper”, “lower”, “lateral”, etc., is used with reference to specific portions of the invention, regardless of the orientation they may assume in the various Figures of the attached drawings. Since components and/or elements and/or embodiments of the invention can be positioned in various different orientations, the directional terminology is used purely for illustrative and non-limiting purposes.

With reference to the attached Figures, a preferred embodiment of an automatic mixing and dosing equipment 100 according to the invention can be observed, configured for dissolving a solid substance, dissoluble in water, to be mixed and dosed in swimming pool water.

The automatic mixing and dosing equipment 100, hereinafter the mixing equipment 100, comprises a box-like frame 101, inside which components of the mixing equipment 100 itself are housed.

It should be noted that the box-shaped frame 101 is illustrated in the attached FIG. 11 while in the attached FIGS. 1, 3-5 it is partially illustrated and in the attached FIGS. 9 and 10 it has been deliberately omitted to facilitate understanding of the mixing apparatus 100 and its internal structure.

Preferably, the box-like frame 101 has a parallelepiped configuration, with a rectangular base, which develops mainly along a vertical direction, that is to say a direction normal with respect to a support plane of the mixing apparatus 100. It is understood that they are possible alternative embodiments of the box-like frame 101 which have different proportions with respect to that illustrated in the attached Figures without any limitation.

The box-like frame 101 comprises side walls that laterally delimit the mixing equipment 100. Some or all of the side walls are connected, removable or fixed, to the box-like frame 101 in a way within the reach of the person skilled in the field.

The mixing equipment 100 is configured to be hydraulically connected along a water treatment plant. In this regard, the mixing apparatus 100 comprises an inlet 102, through which water drawn for example from a swimming pool system not shown in the attached Figures is sucked, and an outlet 103, through which a mixture comprising water and a dissolved substance is delivered to be introduced into the above mentioned system.

Preferably, the inlet 102 and the outlet 103 are delimited along the same side of the mixing apparatus 100, although it is understood that alternative positions are possible, depending on specific use requirements.

The term inlet and outlet are intended to indicate hydraulic connections to which pipes can be operatively connected in a manner within the reach of the person skilled in the sector.

The mixing apparatus 100, inside the box-like frame 101, comprises a suction line 200, in fluid communication with the inlet 102, a hydraulic pump 300 operatively connected in suction to the suction line 102, a first delivery line 400 connected to the hydraulic pump 300 to feed the water sucked towards a tank compartment 500 delimited at a top of the mixing apparatus 100, wherein the tank compartment 500 comprises a perforated basket 501 wherein to house a solid material to be dissolved, a dispenser 502 operatively connected to the first delivery line 400 and configured to selectively deliver jets of pressurized water inside the perforated basket 500, a collection tank 503 wherein to collect the dissolved material which emerges from the perforated basket 501, a second delivery line 600 in fluid communication with the delivery of pump 300 and with the outlet 103 of the mixing apparatus, and a mixing line 700 which places the collection tank 503 in fluid communication with the second delivery line 600, wherein the mixing line 700 is connected in fluid communication with the second delivery line 600 via a Venturi tube 601.

It should be noted that the perforated basket 501 and the collection tank 503 are made of plastic or more generally of an impermeable material which is chemically compatible with chlorine.

In this regard, it should be noted that, in general, the components of the mixing apparatus 100 that come into contact with the chlorine solution are chemically compatible with chlorine and free from metal parts in direct contact with chlorine.

The operation of a Venturi tube 601 is considered to be within the reach of the person skilled in the art and, therefore, will not be described.

The mixing apparatus 100 comprises a filter 201 arranged along the suction line 200, therefore upstream of the pump 300 (see FIGS. 9 and 10), to filter any debris present in the sucked water, preventing them from being introduced in pump 300 compromising its operation.

The mixing apparatus 100 includes an inlet valve 202, positioned along the suction line 200 to selectively intercept it and allow, for example, a safe maintenance of the mixing apparatus 100 avoiding any flooding.

Preferably, the inlet valve 202 is interposed between the inlet 102 and the filter 201.

As mentioned, the first delivery line 400 places the delivery of the pump 300 in fluid communication with the tank compartment 500.

In particular, the first delivery line 400 comprises a first branch 401 for the communication connection of fluid between the first delivery line 400 and the dispenser 502 and a second branch 402 for the communication connection of fluid between the delivery line 400 the inside of the collection tank 503 (see FIGS. 3, 5 and 9).

With reference to the preferred embodiment illustrated in the attached Figures, the second branch 402 protrudes from the first delivery conduit 400 in an interposed position between the connection of the first branch 401 and the first delivery conduit 400 and the pump 300. It is understood that it is an alternative embodiment is possible, not illustrated in the attached Figures, wherein the first branch 401 protrudes from the first delivery line 400 in an interposed position between the connection of the second branch 402 and the pump 300.

The mixing apparatus 100 includes a delivery tube 504 which extends inside the collection tank 503 and is connected, in fluid communication, to one end of the second branch 402 (see, for example, FIG. 5).

The mixing apparatus 100 comprises a first delivery valve 403 connected to the first delivery line 400 to selectively intercept the first branch 401 and a second delivery valve 404 connected to the first delivery line 400, to selectively intercept the second branch 402 and the first branch 401 (see, for example, FIGS. 1 and 9).

The mixing apparatus 100 comprises a control logic unit 104 which controls its operation. In this regard, it should be noted that the control logic unit 104 is operationally connected to the pump 300, to selectively control its switching on/off. Furthermore, the control logic unit 104 is operatively connected to the first delivery valve 403 and to the second delivery valve 404 to selectively control their opening or closing. According to a preferred embodiment, the first delivery valve 403 and the second delivery valve 404 are solenoid valves. The control logic unit 104 is of the programmable type and for this purpose comprises a keypad for entering or modifying the operating parameters and a display through which to show such parameters or information or warnings relating to the operation of the mixing apparatus 100, according to modality within the reach of the person skilled in the sector.

The mixing apparatus 100 includes at least one power switch 105, operationally connected to the control logic unit 104 to selectively interrupt the power supply of the same and, therefore, of the mixing equipment 100 (see FIG. 1).

As mentioned, the mixing apparatus 100 comprises a tank compartment 500 which delimits a top opening through which to introduce the chlorine tablets.

The mixing apparatus 100 comprises a lid 106, which is hinged to a top of the mixing apparatus 100 itself, to close an access opening to the tank compartment 500.

The lid 106 comprises an insert 107 embedded within it, preferably in correspondence with an edge of the lid 106, schematically illustrated in the attached FIG. 3, configured to interact with a sensor 108 arranged at the tank compartment 500 in such a way as to detect when the lid 106 is open. The sensor 108 is operationally connected to the control logic unit 104.

The lid 106 acts as a safety closure preventing the material to be dissolved from escaping or accidentally coming into contact with an operator who is near the mixing equipment 1.

In general, the material to be dissolved is chlorine in the form of tablets and, as known, as this irritant material it is necessary to avoid its contact and inhalation.

The dispenser 502, according to a preferred embodiment, has a frame shape and includes a hydraulic inlet connection 505, connected to the first branch 401 of the first delivery line 400 (see the detail view of FIG. 2).

The dispenser 502 includes two perforated tubes 506 which develop parallel to each other along a longitudinal direction and are mechanically joined and in fluid connection through transverse tubes 507.

The hydraulic connection 505 is connected to one end of one of the transverse tubes 507, so as to extend at a vertex of the frame structure, for the purposes that will be described below.

Each of the perforated tubes 506 has a plurality of through holes which are arranged in alternating succession to each other along two angularly offset rows 508, 509.

In practice, the holes of a first row 508 are offset with respect to the holes of a second row 509, so as not to be side by side or paired (see FIG. 12).

The holes are positioned in such a way that the water jets dispensed by them are turned towards the inside of the perforated basket 501, which the dispenser 502 faces.

Preferably, the holes of one of the two perforated tubes 506 are arranged and oriented in such a way as to allow a substantially uniform delivery of the water jets towards the inside of the perforated basket 501.

The holes have a diameter of a few millimeters, preferably between 1 mm and 3 mm and can all have the same diameter or different diameters according to specific use requirements. It has been found that this size of the holes allows the delivery of powerful jets of water capable of engraving and cutting the chlorine tablets.

In use, the dispenser 502 is positioned so that it faces the top of the perforated basket 501 to deliver jets of pressurized water inside the latter.

The dispenser 502 is mobile connected to the mixing apparatus 100 in order to be removed relative to the perforated basket 501 so as to be able to remove the perforated basket 501 itself from the tank compartment 500 if necessary (see the exploded diagram of FIG. 5).

The dispenser 502 is in fact hinged to a side of the mixing apparatus 100 so as to be selectively rotatable around a rotation axis 510 between a raised position (see for example FIG. 5), wherein it is placed away from the perforated basket 501 and a lowered position, wherein it is placed against a top portion of the perforated basket 501 (see for example FIG. 9). In particular, the dispenser 502 is hinged to one side of the tank 503.

In this regard, it should be noted that the lid 106 has dimensions such as to delimit an opening at the top of the mixing apparatus 100 sufficient to allow at least partial release of the dispenser 502, as well as the possible extraction of the perforated basket 501.

The hydraulic connection 505 has a rotating joint configured to allow relative rotation between the dispenser 502 and the first branch 401, while ensuring a hydraulic seal of their connection.

The perforated basket 501 is configured as a basket bounded between side walls and a perforated bottom.

The perforated basket 501 is configured to house and hold within it pads or tablets or balls of chlorine or a solid material to be dissolved and to allow the dissolved product to pour through the perforated bottom.

It should be noted that according to a preferred embodiment, the perforated basket 501 has lateral holes 511 made passing through the side walls of the perforated basket 501 at the perforated bottom, to promote the release of the dissolved product, avoiding stagnation (see for example FIG. 5).

The perforated basket 501 can be removed from the tank compartment 500 and has delimited grip openings 512 passing through at least one of the side walls, at a top of the perforated basket 501, to facilitate its gripping and handling (see ad example FIG. 5, wherein only some of the intake openings 512 have been indicated to avoid excessively weighing this Figure).

The perforated basket 501 has housing seats 513 delimited at its top, configured to at least partially house the perforated tubes 506 and easily position the dispenser 502 relative to the perforated basket 501 according to a predetermined positioning.

By way of example, the housing seats 513 are shaped like notches complementary to the diameter of the perforated tubes 506.

It should be noted that the perforated basket 501 has a greater width dimension than the separation distance between the perforated tubes 506 and a smaller length dimension than the separation distance between the transverse tubes 507 of the dispenser 502.

Preferably, each of the perforated tubes 506 has respective holes along the section that faces the inside of the plan dimensions of the perforated basket 501 to direct the jets of water only inside the latter.

Optionally, the perforated basket 501 has a reference or a mark inside at least one of the walls of the perforated basket 501 itself, to indicate an optimal filling level, promoting a correct filling operation by an operator.

The mixing apparatus 100 has 514 brackets for supporting the perforated basket 501.

The brackets 514 are positioned at the top of the mixing apparatus 100, inside the tank compartment 500 and provide feedback on which the perforated basket 501 can be placed.

Optionally, each of the brackets 514 has notches 515 wherein to house the respective bottom portions 516 of the perforated basket 501, which protrude precisely from the bottom of the latter (see FIG. 5).

The presence of the notches 515 makes it possible to position the perforated basket 501 inside the tank compartment 500 in a predetermined and therefore optimal manner for the operation of the mixing apparatus 100, facilitating the insertion of the perforated basket 501 and thus reducing the time required to perform this operation.

The collection tank 503 develops inside the tank compartment 500 below the basket 501, in such a way as to intercept the dissolved material that pours through the bottom of the perforated basket 501.

The collection tank 503 has an inclined bottom 517, configured to convey the liquid-a solution saturated with chlorine-which flows from the perforated basket 501 towards a collection point.

In the attached Figures the collection tank 503 is partially shown since some of its lateral containment walls have been deliberately removed or not shown to allow showing the internal conformation of the collection tank 503 itself.

The delivery tube 504 is positioned at a top of the collection tank 503 and, therefore, at a top portion of the inclined bottom 517.

The delivery tube 504, preferably, develops along a direction parallel or substantially parallel to the axis of rotation 510 or, in other words, transversely with respect to the collection tank 503.

The delivery tube 504 has a plurality of holes not illustrated in detail in the attached Figures, through which water is delivered in the direction of the inclined bottom 517. The holes are made substantially along the entire length of the delivery tube 504 to allow a substantially uniform delivery of water along the entire width of the inclined bottom 517.

Through the delivery tube 504 it is possible to deliver water to remove any deposits or traces of dissolved substance coming from the perforated basket 501, keeping the collection tank 503 clean and allowing the recovery of any dissolved material deposited along the inclined bottom 517.

In addition, the supply of water through the delivery tube 504 allows you to adjust the concentration of the dissolved substance present in the collection tank 503, possibly further diluting it according to specific use requirements.

The mixing apparatus 100 comprises an outlet valve 518 positioned at a bottom portion of the inclined plane 517 and configured to selectively place the collection tank 503 in fluid communication with the mixing line 700 (see for example FIG. 4).

The outlet valve 518 is made of plastic or a non-metallic waterproof material resistant to the oxidizing action of chlorine.

The outlet valve 518 is shown in an exploded configuration in the attached FIG. 7.

As mentioned, the mixing line 700 is connected to a Venturi tube 601 in such a way as to determine the aspiration of the liquid contained within the collection tank 503. The outlet valve 518 is configured to prevent or minimize the intake of air inside the mixing line 700 during the final stages of emptying the collection tank 503, wherein there is a minimum amount of liquid to be sucked.

Since the collection tank 503 contains a chlorine solution, any air trapped in the solution delivered by the mixing apparatus 100 would be introduced into the flow leaving the mixing apparatus 100, causing the emission of bubbles in the system to which the mixing apparatus 100 is connected. The presence of bubbles causes a sudden and undesirable release of chlorine into the atmosphere when the bubbles reach the surface and, for this reason, it is preferable to avoid the above-mentioned mixing of air.

The outlet valve 518 comprises a valve body 519 configured as a perforated cage, connectable to a seat 520 delimited along a portion of the inclined bottom 517, inside which a spherical float 521 is retained, and an annular support 522 positioned at the bottom of the valve, that is to say in correspondence with the seat 520, against which the spherical float 521 selectively strikes to determine the progressive closing of the outlet valve 518, according to the level of the liquid which is present in the collection tank 503.

The spherical float 521 is movable inside the body of the valve 519 between a raised position, wherein the spherical float 521 is moved away from the annular support 522, causing the opening of the outlet valve 518, and a lowered position wherein the spherical float 521 abuts against the annular support 522, causing the closure of the outlet valve 518.

As mentioned, the position taken by the spherical 2float 521 inside the body of the valve 519 is a function of the level of the liquid present in the collection tank 503.

The annular support 522 is internally flared to provide a greater abutment surface and, therefore, a sealing surface for the spherical float 521.

It should be noted that the annular support 522 has radial notches 523 which pass radially through the annular support 522 and define respective passage openings through a bottom portion of the outlet valve 518.

With reference to the embodiment illustrated in the attached FIG. 7, the annular support 522 has four radial notches 523 arranged equidistant from each other according to a circular symmetry with respect to a central symmetry axis for the annular support 522 itself, not illustrated in the attached Figures. It is understood that alternative embodiments of an annular support 522 are possible, comprising a greater or lesser number of radial notches 523 even if arranged equidistant from each other according to a circular symmetry.

The radial notches 523 allow a progressive closure of the outlet valve 518 allowing the suction of the liquid contained in the collection tank 503 during the final stages of emptying, avoiding the intake of air through the outlet valve 518 itself. In fact, in the final stages of emptying, the liquid sucked in through the outlet valve 518 can pass through passage openings delimited between the radial notches 523 and the bottom portion of the spherical float 521.

The filling of the collection tank 503 causes the liquid to rise inside it, causing the lifting of the spherical float 521 held inside the body of the valve 519, thus freeing an outlet opening delimited along a flat portion of the inclined bottom 517.

The mixing apparatus 100 includes at least one level sensor 524 positioned inside the collection tank 503 to detect the achievement of a maximum filling level inside it. The level sensor 524 is operationally connected to the control logic unit 104 and, preferably, is a rotary sensor even though it is intended that it is possible to use a different type of level sensor.

Optionally, the mixing apparatus 100 comprises a further level sensor 525, positioned inside the collection tank 503, to detect the achievement of a minimum filling level in the collection tank 503. It follows that the further sensor of level 525 is positioned inside the collection tank 503 at a lower level than that of the level sensor 524 or, in other words, at a distance from the bottom of the collection tank 503 lower than that of the level sensor 524.

The additional level sensor 525 is operationally connected to the control logic unit 104 and is configured similarly to the level sensor 524.

As mentioned, the mixing apparatus 100 includes a second delivery line 600 which places the first delivery line 400 in fluid communication with the outlet 103, as well as the mixing line 700 with the outlet 103.

In particular, the mixing apparatus 100 includes a “T” fitting 405 which places the first delivery line 400 and the second delivery line 600 in fluid communication (see for example FIG. 8). Therefore, one end of the second delivery line 600 is connected to the “T” fitting 405 and the opposite end is connected to the outlet 103 of the mixing apparatus 100.

The mixing line 700 is connected to the second delivery line 600 through a Venturi tube 601 interposed along the second delivery line 600. In particular, the mixing line 700 is connected to the depression branch of the Venturi tube 601 in such a way that the passage of water through the second delivery line 600 and through the Venturi tube 601 determines the depression inside the Venturi tube 601 and a depression in the branch to which the mixing line 700 is connected, thus recalling the mixture coming from the collection tank 503.

It should therefore be noted that the second delivery line 600 is in fluid communication with the outlet 103 through the Venturi tube 601 which is positioned along a section of the second delivery line 600 itself.

The mixing apparatus 100 includes a hollow base 109 on which the mixing apparatus 100 itself rests.

The hollow base 109 has a greater overall dimensions than that of the box-shaped frame 101 and is configured as a collection tank for any mixture present in excess in the collection tank 503.

With reference to the preferred embodiment illustrated in the attached FIG. 11, the hollow base 109 has a bottom 110 perimetrically delimited by side walls 111, wherein the hollow base 109 comprises inside it some crosspieces 112 which support the mixing apparatus 100 in raised position with respect to the ground 110.

Each of the crosspieces 112 defines a transverse wall along the hollow base 109 and has at least one through opening 113 for placing the individual portions of the hollow base 109 in fluid communication, delimited between the side walls 111 and the crosspieces 112, promoting a uniform distribution of the liquid if necessary collected inside.

The mixing apparatus 100 includes a vent line 800 which places the interior of the collection tank 503 in fluid communication with the hollow base 109 (see for example FIG. 11).

The vent line 800 has a top inlet 801 (see for example FIG. 8) which faces the inside of the collection tank 503, at a predetermined distance with respect to a bottom portion of the collection tank 503 itself and defines the maximum filling level for the collection tank 503 and an outlet end 802 placed inside the hollow base 109.

The hollow base 109 and the vent line 800 are a safety element for the operation of the mixing apparatus 100 allowing the recovery of any liquid fed in excess inside the collection tank 503 in addition to a predetermined maximum level.

The presence of the hollow base 109, which delimits a tank, allows to recover the excess liquid that comes out of the collection tank 503, collecting it inside, thus avoiding dirtying and contaminating the environment surrounding the mixing apparatus 100.

It should be noted that the mixing apparatus 100 includes a drainage cap 526 positioned along the tank compartment 500, at a bottom portion of the collection compartment 503 (see, for example, FIG. 5).

The drainage cap 526, when removed, frees an opening positioned at t a portion of the bottom of the collection compartment 503, allowing you to drain any mixture present inside the collection compartment. Furthermore, the drain plug 526 hermetically occludes a service opening through which to access the collection compartment 503.

The mixing apparatus 100 includes shut-off valves positioned along the first delivery line 400 and along the second delivery line 600 to selectively intercept them and allow, for example, to carry out maintenance on the mixing apparatus 100 avoiding flooding.

In this regard, the mixing apparatus 100 comprises a third delivery valve 406 (see FIGS. 8 and 9) interposed between the delivery of the pump 300 and the “T” fitting 405. The third delivery valve 406 allows to selectively intercept the delivery upstream of the “T” fitting 405 (see FIG. 8).

The mixing apparatus 100 comprises a fourth delivery valve 407 positioned along the first delivery line 400, in a position interposed between the “T” fitting and the second branch 402. More precisely, the fourth delivery valve 407 is positioned at downstream of the second delivery valve 404 and is configured to selectively intercept the first delivery line 400 in a section upstream of the “T” fitting 405 and downstream of both the first branch 401 and the second branch 402.

The mixing apparatus 100 includes a fifth delivery valve 408 positioned along the second delivery line, in a position interposed between the Venturi tube 601 and the outlet 103.

The fifth delivery valve 408 allows you to selectively intercept the outlet 103, performing a function similar to that described in relation to the inlet valve 202 and the inlet 102. Optionally, the mixing apparatus 100 includes an auxiliary tank 527 housed in correspondence with the tank compartment 500 and configured to act as an accumulator for the chlorine solution prepared inside the tank compartment 500.

The auxiliary tank 527 is connected in fluid communication with the collecting tank 503 through an auxiliary line 528 (see for example FIG. 10).

The auxiliary line 528 has one end in fluid communication with the collection tank 503 and an opposite end in fluid communication with the auxiliary tank 527.

The mixing apparatus 100 comprises an auxiliary outlet valve 529 placed inside the collection tank 503 and configured to selectively close the opening which places the collection tank 503 in fluid communication with the auxiliary line 527 as a function of the level of liquid which is in the collection tank 503 itself (see FIG. 7).

The 529 auxiliary outlet valve is made of plastic or a non-metallic waterproof material resistant to the oxidizing action of chlorine.

The auxiliary outlet valve 529 is configured in a similar way to the outlet valve 518 to which reference is made in its entirety.

In practice, the auxiliary outlet valve 529 comprises a respective spherical float 530 configured to move inside a respective valve body 531, wherein the respective valve body 531 is engageable in a respective seat 532 delimited at the bottom of the collection tank 503 (see FIG. 7).

The respective spherical float 530 can be moved selectively, according to the level of liquid present inside the collection tank 503, between a raised position, wherein it is raised and spaced from a respective annular support 533 placed along the bottom of the collection tank 503, freeing an outlet opening of the auxiliary outlet valve 529 and a lowered position, wherein it abuts against the respective annular support 533, occluding the outlet opening and thus occluding the auxiliary line 528.

The mixing apparatus 100, when it comprises an auxiliary tank 527, comprises an auxiliary delivery line 534 which connects, in fluid communication, the auxiliary tank 527 and the mixing line 700, allowing to feed the mixing line 700 through the auxiliary tank 527 (see, for example, FIG. 10). The auxiliary delivery line 534 is in fluid communication with the interior of the auxiliary tank 527 through an outlet configured as a through opening delimited through a bottom of the auxiliary tank 527 itself, see for example FIG. 10.

The auxiliary delivery line 534 is connected to the mixing line 700 along a section upstream of the Venturi tube 601.

It should be noted that the auxiliary delivery line 534 comprises a shut-off valve 535; positioned along the auxiliary delivery line 534 and configured to selectively intercept it (see, for example, FIGS. 4, 8 and 10).

The shut-off valve 535 is a solenoid valve and is operationally connected to the control logic unit 104, so as to be commanded to open or close according to the operating parameters of the mixing apparatus 100.

The mixing apparatus 100 includes at least one auxiliary level sensor 536 housed inside the auxiliary tank 527 and operationally connected to the control logic unit 104 (see FIG. 8).

The auxiliary level sensor 536 detects the reaching of a maximum level of liquid inside the tank 527 according to the methods described in relation to the level sensor 524 to which reference is made.

The operation of the mixing apparatus 100 according to the invention is summarized below, assuming that the inlet 102 of the mixing apparatus 100 is hydraulically connected to a line coming from a swimming pool, not shown in the attached Figures, and the outlet 103 is hydraulically connected to a water delivery line to be introduced into the pool.

Chlorine tablets are introduced inside the tank compartment 500, lifting the lid 106 and freeing an access to the perforated basket 501.

After having introduced the necessary quantity of chlorine in solid form inside the perforated basket 501, the lid 106 is closed, bringing the insert 107 embedded in the lid 106 itself near the sensor 108, which provides the consent for the operation of the mixing apparatus 100.

The control logic unit 104, based on the operating parameters of the mixing apparatus 100 that can be set via a panel operatively connected to the control logic unit 104 itself, determines the activation of the pump 300.

The actuation of the pump 300 causes the suction of water through the inlet 102 and the suction line 200. The sucked water is then pushed into the delivery by pump 300 along the first delivery line 400.

The control logic unit 104 controls the activation of the first delivery valve 403 and the second delivery valve 404 according to the operations to be performed.

In the event that it is necessary to produce a chlorine solution to be delivered through outlet 103, the first delivery valve 403 and the second delivery valve 404 are commanded in the open position, allowing pressurized water to be supplied to the dispenser 502 and the delivery tube 504.

The jets of pressurized water delivered by the dispenser 502 hit the chlorine tablets contained in the perforated basket 501, engraving and/or cutting and dissolving them. The saturated chlorine solution thus obtained drips through the bottom of the perforated basket 501 falling into the collection tank 503 wherein it is collected. At the same time, pressurized water is delivered from the delivery tube 504 towards the inclined bottom 517, promoting the accumulation of the chlorine mixture towards the bottom of the collection tank 503.

The filling of the collection tank 503 continues until the level of mixture inside it reaches a predetermined level, which is detected through the level sensor 524.

Then, the second delivery valve 404 is closed, blocking the further introduction of water into the tank compartment 500.

With the collection tank 503 filled with a mixture of water and chlorine, the opening of the outlet valve 518 is determined, since the spherical float 521 is in a raised position with respect to the annular support 522, thus placing the mixing line 700 in fluid communication with the inside of the collection tank 503.

If the mixing apparatus 100 includes an auxiliary tank 527, the auxiliary outlet valve 529 is also placed in the open position, placing the auxiliary tank 527 in fluid communication with the interior of the collection tank 503 through the auxiliary line 528.

The filling of the collection tank 503 continues until the level of the chlorine solution inside the collection tank 503 reaches a predetermined maximum level, which is detected by the level sensor 524. Upon reaching the maximum predetermined level inside of the collection tank 503, the level sensor 524 transmits a signal to the logic control unit 104 which commands the closing of at least the first delivery valve 403, interrupting the water supply to the first branch 401 and, consequently, the supply of pressurized water from the dispenser 502.

The delivery of water along the second branch 402 continues for a predetermined washing time, to allow the washing of the inclined bottom 517 and remove any residues of the mixture of water and chlorine.

After this rinsing time, the control logic unit 104 commands the closing of the second delivery valve 404, thus intercepting the second branch 402 and interrupting the supply of water from the delivery line 504.

Meanwhile, the control logic unit 104 keeps the hydraulic pump 300 active, causing the chlorine solution to be sucked from the collection tank 503, through the suction action of the Venturi tube 601 which is connected, in fluid communication, with the inside of the collection tank 503 itself, through the mixing line 700.

During the final phase of emptying the collection tank 503, the outlet valve 518 allows the recall of the chlorine solution, preventing the entry of air into the mixing line 700, air which would otherwise be delivered together with the mixture of water and chlorine through the exit 103.

The further level sensor 525, if present, detects the achievement of a minimum filling condition of the collection tank 503 starting from which the hydraulic pump 300 is kept running for a predetermined time interval, sufficient for the complete emptying of the collection tank 503.

At the end of the dissolving and mixing cycle, the control logic unit 104 stops the operation of the hydraulic pump 300.

With reference to what has been described, it is clear that the mixing equipment according to the invention is able to achieve the intended purposes.

It should be noted that the mixing apparatus 100 is easily implemented in a swimming pool plumbing system by exploiting the water that circulates in this system to produce and mix a chlorine solution within the water to be fed into the pool.

The mixing apparatus 100 allows to prepare a chlorine solution to be mixed in a swimming pool system in a short time and in a completely automatic way, minimizing the manipulation of chlorine by the operator and the time wherein the operator itself exposes itself to chlorine.

In fact, an operator simply feeds the chlorine tablets or tablets inside the tank compartment 500, inside the perforated basket 501. The time wherein an operator interacts with the chlorine is thus reduced to a minimum.

The mixing apparatus 100 is contained within a box-like frame 101 so that the chlorine is kept inside, isolated from the external environment.

The logic control unit 104 automatically controls the operation of the mixing apparatus 100, allowing flexible operation as regards the preparation, on request, of the chlorine solution, the quantity of solution to be prepared, as well as the concentration of chlorine in the solution itself.

The mixing apparatus 100 is extremely flexible in use, as it can also be used in swimming pools of various capacities, understood as the quantity of water contained in the swimming pool and in the relative system, and allowing a precise and constant regulation of the chlorine concentration in the water of the pool itself.

It should be noted that if it is necessary to modify the flow rate of the fluid moved inside the mixing apparatus 100 through the pump 300, it is possible to use valves to regulate the passage section of the pipes included inside the mixing apparatus 100 according to methods within the reach of the person skilled in the art.

The use of level sensors 524, 525 inside the collection tank 503 makes it possible to detect any anomalies in the mixing apparatus 100, and to interrupt its operation to allow the verification of a malfunction or the possible repair of a fault. The presence of a vent line 800 which flows into the hollow base 109 and which is in fluid communication with the interior of the collection tank 503, avoids the internal flooding of the mixing apparatus 100 in the event of an excessive filling of the collection tank 503 itself, beyond a predetermined maximum filling level.

It should also be noted that the mixing apparatus 100 is configured to keep the collection tank 503 clean at the end of each preparation cycle of the liquid chlorine solution, ensuring high operating efficiency and reducing maintenance intervals.

Optionally, the mixing s 100 comprises a dispensing device 301 for the controlled dispensing of an acid substance to be selectively fed into the collection tank 503, to allow its cleaning, with particular reference to the cleaning of the inclined bottom 517.

The delivery device 301 comprises a peristaltic pump in fluid communication with the second branch 402 through a line not illustrated in detail in the attached Figures.

In particular, the second branch 402 has a hydraulic connection 409 for communicating fluid connection with a dispensing device 301 (see for example FIGS. 5 and 9).

The dispensing device 301 comprises a tank wherein the acid substance to be dispensed is contained or is connected, in fluid communication, with a tank wherein the acid liquid is contained.

The dispensing device 301 is schematically illustrated in the attached FIG. 8 and has not been described in detail since such a device and its operation are considered within the reach of the person skilled in the art.

The mixing apparatus 100 is therefore able to perform an internal cleaning cycle in an automated way, as part of a reliable solution that requires limited intervention by a user.

In the foregoing, the preferred embodiments have been described and variants of the present invention have been suggested, but it is to be understood that those skilled in the art will be able to make modifications and changes without thereby departing from the relative scope of protection, as defined by the attached claims.

1. An automated mixing and dosing apparatus, comprising:
a suction line, in fluid communication with an inlet through which to suck water,
hydraulic pump operatively connected in suction to said suction line,
a programmable logic control unit, operatively connected to said hydraulic pump to selectively control its operation,
a first delivery line connected to said hydraulic pump in delivery to feed said water sucked towards a tank compartment delimited at a top of said mixing apparatus,
wherein said tank compartment comprises:
a perforated basket wherein to house a solid material to be dissolved,
a dispenser operatively connected to said first delivery line, wherein said dispenser is positioned at a top of said perforated basket and is configured to selectively deliver jets of water in pressure inside said perforated basket to dissolve the solid material contained therein,
a collection tank wherein to collect a saturated solution of said dissolved material which flows through a bottom of said perforated basket,
a second delivery line in fluid communication, at delivery, with said hydraulic pump and with an outlet of said mixing apparatus through which to deliver a mixed liquid,
a mixing line which places said collection tank in fluid communication with said second delivery line, wherein said mixing line is connected in fluid communication with said second line through a Venturi tube connected along a section of said second delivery line so that the passage of water through said second delivery line determines the suction of said solution contained in said collection tank by effect of said Venturi tube, mixing said solution with said water which is then delivered through said outlet.

2. The mixing and dosing apparatus according to claim 1, wherein said dispenser has a frame shape and comprises a hydraulic inlet connection connected to a first branch, wherein said first branch protrudes in fluid communication from said first delivery line, wherein said dispenser comprises two perforated tubes which extend parallel to each other and are mechanically joined and in fluid connection by means of respective pipes transversal, said perforated tubes being in fluid communication with said hydraulic inlet connection.

3. The mixing and dosing apparatus according to claim 2, wherein each of said perforated tubes has a plurality of through holes which are arranged in alternating succession to each other along a first row and a second row, wherein said first row and said second row are angularly offset from each other and wherein the holes of said first row are offset with respect to the holes of a second row, said holes being positioned so that the jets of water dispensable by them are directed towards the inside of said perforated basket on which said dispenser faces inside said tank compartment.

4. The mixing and dosing apparatus according to claim 2, wherein said hydraulic inlet connection is connected to one end of one of said transverse tubes, so as to extend at a vertex of said frame structure, wherein said hydraulic inlet connection is rotatable around a rotation axis to allow the lifting or lowering of said dispenser relative to said perforated basket.

5. The mixing and dosing apparatus according to claim 1, comprising brackets for supporting said perforated basket in an elevated position with respect to said collection tank, said brackets being positioned at the top of the mixing apparatus, inside said tank compartment.

6. The mixing and dosing apparatus according to claim 1, comprising a delivery tube which extends inside a top portion of said collection tank and is connected, in communication of fluid, to a second branch which extends into fluid communication with said first delivery line, said delivery tube comprising a plurality of holes through which jets of pressurized water can be delivered directed towards an inclined bottom on which said dispensing tube faces, wherein said inclined bottom defines a bottom of said collection tank.

7. The mixing and dosing apparatus according to claim 2, comprising a first delivery valve configured to selectively intercept said first branch and a second delivery valve configured to selectively intercept said second branch, wherein said first delivery valve and said second delivery valve are operatively connected to said control logic unit.

8. The mixing and dosing apparatus according to claim 1, comprising a lid hinged to a top portion of said mixing and dosing apparatus, wherein said lid selectively frees a access opening to said tank compartment, wherein said lid comprises an insert embedded in it and configured to interact with a sensor arranged at said tank compartment, wherein said sensor is operatively connected to said logic control unit and configured to detect when said lid is in the closed position.

9. The mixing and dosing apparatus according to claim 1, comprising an outlet valve configured to selectively intercept a fluid communication between said collection tank and said mixing line, wherein said outlet valve comprises a valve body configured as a perforated cage inside which a shutter configured as a spherical float is housed, wherein the spherical float can be moved between one position opening and a closing position according to the level of the liquid contained in said collection tank.

10. The mixing and dosing apparatus according to claim 1, comprising an auxiliary tank, an auxiliary line which places said auxiliary tank in fluid communication with the interior of said tank collection tank, and an auxiliary outlet valve positioned inside said collection tank and configured to selectively place said auxiliary tank and said collection tank in fluid communication, selectively intercepting said auxiliary line as a function of the level of liquid included in said collection tank.

11. The mixing and dosing apparatus according to claim 10, comprising an auxiliary delivery line which connects, in fluid communication, an outlet of said auxiliary tank with said mixing line, along a portion of said mixing line upstream said Venturi line, wherein said auxiliary delivery line comprises a shut-off valve configured to selectively intercept it, said shut-off valve being operatively connected to said logic control unit.

12. The mixing and dosing apparatus according to claim 1, comprising a hollow base on which said mixing and dosing apparatus rests, said hollow base having a bottom bounded perimeter by side walls and comprising inside it some crosspieces which support said mixing and dosing apparatus in a raised position with respect to said bottom, wherein said mixing and dosing apparatus comprises a vent line which puts in communication fluid the inside of said collection tank with said hollow base when said liquid contained in said collection tank exceeds a predetermined maximum level.

13. The mixing and dosing apparatus according to claim 6, comprising a dispensing device for the controlled dispensing of an acid substance to be selectively fed into said collection tank through said dispensing tube, wherein said delivery device comprises a peristaltic pump in fluid communication with a hydraulic connection connected along said second branch, wherein said delivery device is operatively connected to said logic control unit.

14. The mixing and dosing apparatus according to claim 6, wherein each of said support brackets has notches for housing respective bottom portions which protrude from a bottom end of said perforated basket.
